(19) United States
(12) Patent Application Publication
(10) Pub. No.: US 2023/0326299 A1
(43) Pub. Date: Oct. 12, 2023

(54) MAINTAINING APPROXIMATELY UNIFORM RETURN TO PLAYER FOR MULTIPLE VOLATILITY OPTIONS RESPONSIVE TO A NUMBER OF TRIGGER SYMBOLS

(71) Applicant: Aristocrat Technologies, Inc., Las Vegas, NV (US)

(72) Inventors: Daniel Mirjavadi, Las Vegas, NV (US); Allon Englman, Las Vegas, NV (US)

(21) Appl. No.: 17/718,492

(22) Filed: Apr. 12, 2022

(51) Int. Cl. G07F 17/32

(52) U.S. Cl. CPC G07F 17/3267; G07F 17/3265; G07F 17/3213

(57) ABSTRACT

A selectable volatility game may be initiated in a triggering game related to a number of trigger symbols landing on a number of reels. The game may utilize one or more multiplier tables. However, there may be significant variance in the return to player between the highest and lowest volatility options depending on whether the number of trigger symbols is low or high. This kind of variance in return to player between volatility options may not be permitted by law, regulation, and so on. In order to maintain uniform and/or substantially uniform return to player, the present disclosure selects and/or adjusts one or more multiplier tables according to the number of trigger symbols. In this way, a player may be provided the chase corresponding to a selectable volatility game while ensuring that the return to player between volatility options remains uniform and/or substantially uniform.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

A selectable volatility game may be initiated in a triggering game related to a number of trigger symbols landing on a number of reels. The selectable volatility game may utilize one or more multiplier tables. However, there may be significant variance in the return to player between the highest and lowest volatility options for the volatility selectable game depending on whether the number of trigger symbols is low or high. This kind of variance in return to player between volatility options in a selectable volatility game may not be permitted by law, regulation, and so on. In order to maintain uniform and/or substantially uniform return to player between volatility options in a selectable volatility game, the present disclosure selects and/or adjusts one or more multiplier tables according to the number of trigger symbols. In this way, a player may be provided the chase corresponding to a selectable volatility game while ensuring that the return to player between volatility options in a selectable volatility game remains uniform and/or substantially uniform.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a flow chart illustrating a first example method for maintaining approximately uniform return to player for multiple volatility options responsive to a number of trigger symbols. The method may be performed by one or more of the devices depicted in FIGS. 1-3.

FIG. 5 depicts a flow chart illustrating a second example method for maintaining approximately uniform return to player for multiple volatility options responsive to a number of trigger symbols. The method may be performed by one or more of the devices depicted in FIGS. 1-3.

FIG. 6 depicts a flow chart illustrating an example method for initiating a selectable volatility game. The method may be performed by one or more of the devices depicted in FIGS. 1-3.

FIG. 7A depicts a first screen of a first game.

FIG. 7B depicts a volatility selection screen illustrating multiple volatility options for a second game that may be initiated from the first game.

FIG. 7C depicts a screen of the second game after a volatility selection is received.

FIG. 7D depicts an example multiplier table that may be used with the second game.

FIG. 7E depicts an example weighted table that may be used with the first game.

### DETAILED DESCRIPTION

A selectable volatility game may be initiated in a triggering game related to a number of trigger symbols landing on a number of reels. The selectable volatility game may utilize one or more multiplier tables. However, there may be significant variance in the return to player between the highest and lowest volatility options for the volatility selectable game depending on whether the number of trigger symbols is low or high. This kind of variance in return to player between volatility options in a selectable volatility game may not be permitted by law, regulation, and so on. In order to maintain uniform and/or substantially uniform return to player between volatility options in a selectable volatility game, the present disclosure may select and/or adjust one or more multiplier tables according to the number of trigger symbols. In this way, a player may be provided the chase corresponding to a selectable volatility game while ensuring that the return to player between volatility options in a selectable volatility game remains uniform and/or substantially uniform.

Selecting the one or more multiplier tables may improve the operation of the electronic device compared to generating the one or more multiplier tables on the fly as the electronic device is not required to spend the processing and/or other resources to generate the one or more multiplier tables on the fly. Reducing processing and/or other resources required frees up processing and/or other resources of the electronic device for other tasks and/or requires the electronic device to have less processing and/or other resources in general.

Adjusting one or more multiplier tables may improve the operation of the electronic device compared to storing different multiplier tables for each number of trigger symbols that might initiate the second game as the electronic device is not required to have the storage space free to store them, as well as requiring less time to search among stored data since less data is stored. Reducing required storage means that the electronic device can be configured with fewer storage resources, as well as freeing up processing time not otherwise used to search among a larger amount of stored data.

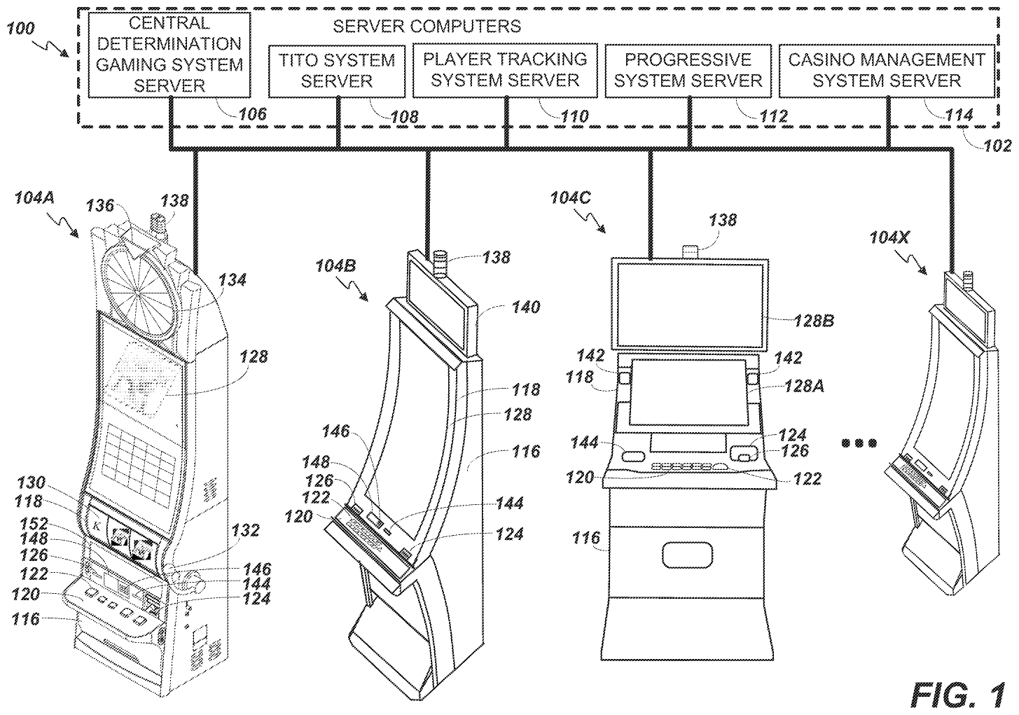

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, the server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

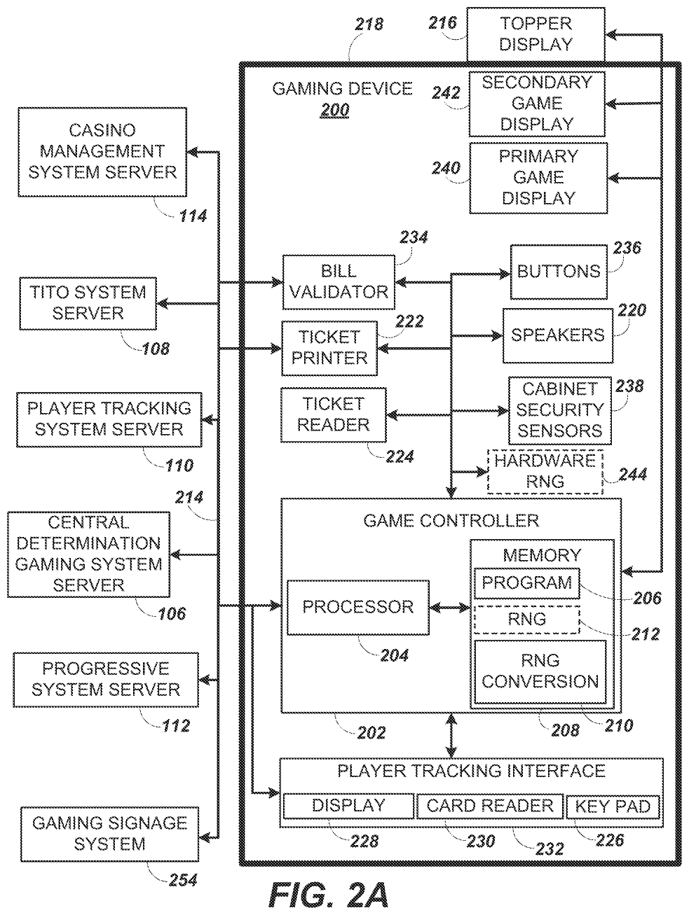

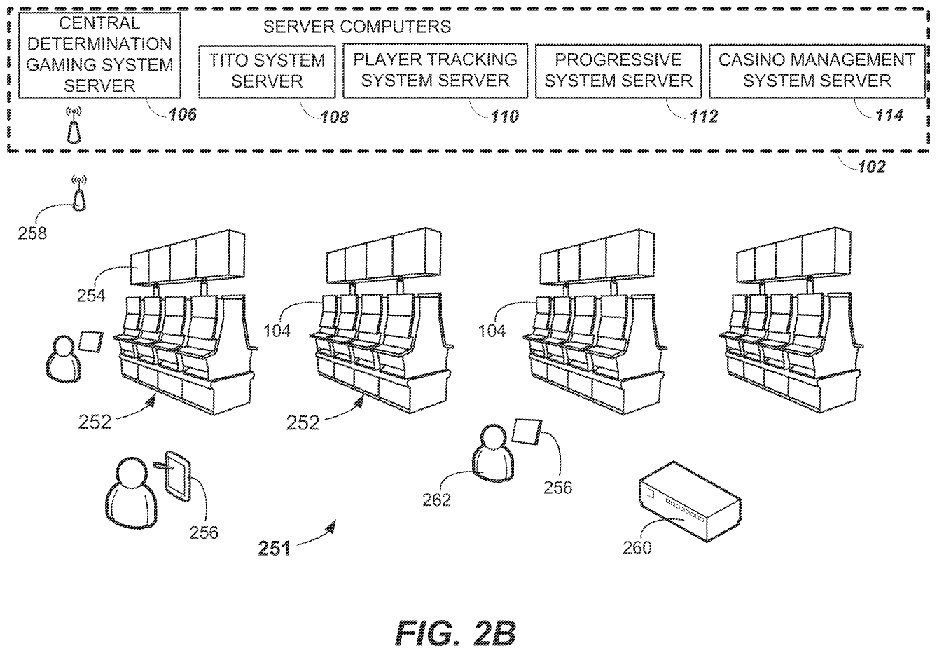

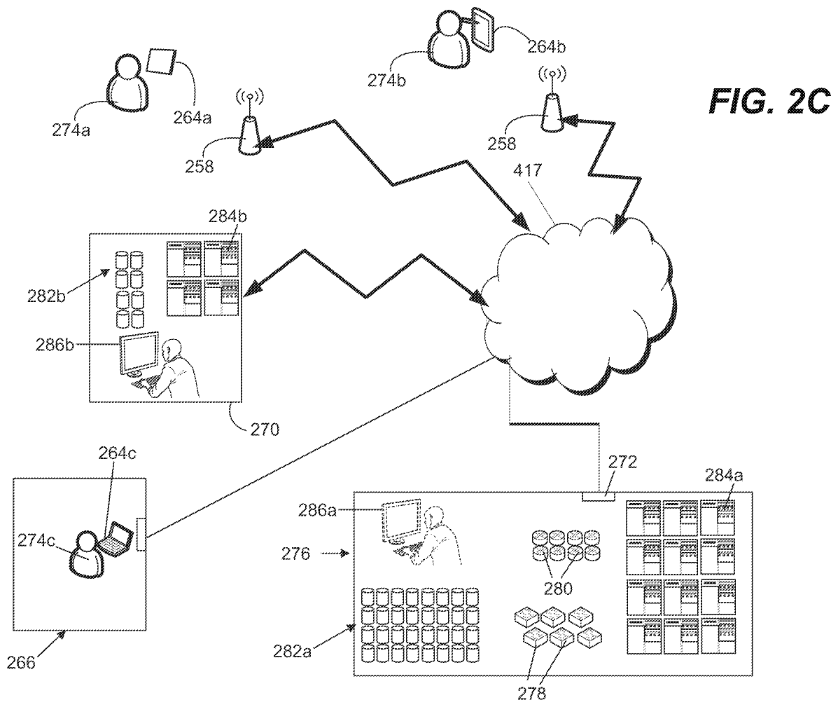

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purposes of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282a and/or servers 284a. Other game-related information and/or software, such as information and/or software relating to leaderboards, players currently playing a game, game themes, game-related promotions, game competitions, etc., also may be stored on storage devices 282a and/or servers 284a. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

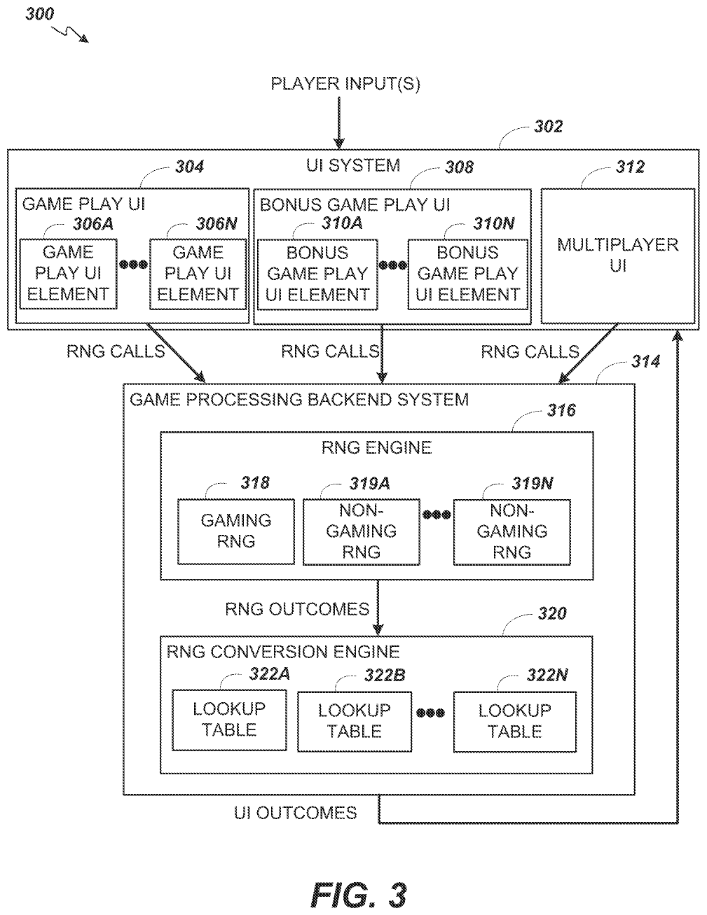

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI elements 306A-306N are similar to the bonus game play UI elements 310A-310N. In other implementations, the game play UI elements 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

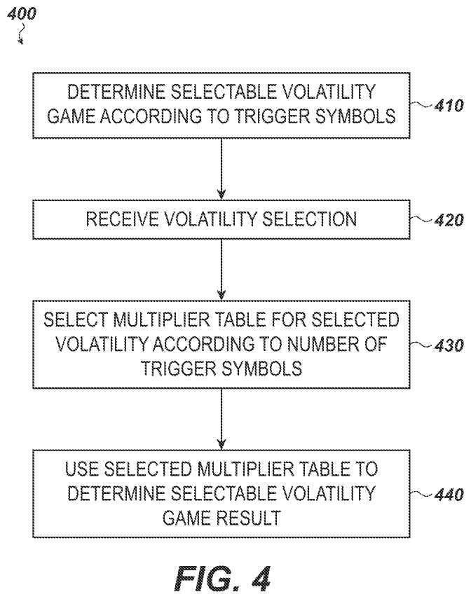

FIG. 4 depicts a flow chart illustrating a first example method 400 for maintaining approximately uniform return to player for multiple volatility options responsive to a number of trigger symbols. The method 400 may be performed by one or more of the devices depicted in FIGS. 1-3.

At operation 410, an electronic device (such as the gaming devices 104, 104A-104X, 200 of FIGS. 1, 2A, and/or 2B, the EUD 264a, 264b and 264c of FIG. 2C, and so on) may determine to initiate a selectable volatility game according to a number of trigger symbols and/or a number of reels on which trigger symbols land. For example, the electronic device may receive user input via a user input system (such as the UI system 302 of FIG. 3) to initiate play of a first game, which may be a slot type game. The slot type game may include a number of reels that may be populated with symbols, such as trigger symbols, from one or more reel strips. The electronic device may use a game processing system backend (such as the game processing backend 314 of FIG. 3) to select one or more stop positions for the one or more reels using a random number generator (such as the gaming RNG 318 of FIG. 3) in order to determine a first game outcome. The electronic device may present the first game and/or the first game outcome via one or more game play interfaces (such as the game play UI 304 of FIG. 3). According to trigger symbols present on a number of reels of the first game outcome (such as 2, 3, and so on), the first game may determine to initiate a second game, which may be the selectable volatility game, a bonus game, and so on. In this way, the first game may be a triggering game.

At operation 420, the electronic device may receive a volatility selection for the second volatility game. The volatility selection may be from among a set of volatility options. In some examples, each volatility option may include features different from the other volatility options, such as a particular number of free spins and/or other game plays, a particular set of multiplier values that may be used at different times during play of the second game (such as that may be selectable from one or more multiplier tables when wild symbols land on one or more reels in one or more different game windows that may be available for play when the game windows are unlocked and unavailable for play when the game windows are locked), and so on.

At operation 430, the electronic device may select one or more multiplier tables for the selected volatility option according to the number of trigger symbols that initiated the second game. For example, in implementations, the second game may include a number of unlocked and locked game windows. The unlocked game windows may include a number of reels similar to the first game. The locked game windows may be unlocked when a cumulative total of trigger symbols summed from the trigger symbols in the first game that initiated the second game and trigger symbols that landed in the second game reaches a particular number (such as 8, 11, and so on). The second game may use the one or more multiplier tables (such as one per game window) to determine when wild symbols land and/or which multiplier values from one or more multiplier value sets to use for the wild symbols, which may multiply the award on any payline (lines (straight or zig-zagged) that cross one symbol on each reel of a slot type game) that crosses the wild symbol. As is discussed in detail below, the fact that the different volatility options may involve different multipliers and the fact that different numbers of trigger symbols may initiate the second game, resulting in different numbers of game windows being more likely to be unlocked with potentially high multiplier values, using the same multiplier tables regardless of the number of trigger symbols that initiate the second game could result in very different return to player between the highest and lowest volatility options. This may not be allowed by one or more laws, gaming regulations, and so on. However, selecting one or more multiplier tables for the selected volatility option according to the number of trigger symbols that initiated the second game may enable the chase for the player of having volatility selection while maintaining uniform and/or substantially uniform (and/or similar and/or substantially similar) return to player between the volatility options. In the context of this application, substantially uniform return to player may be when the ratio between the highest return to player and the lowest return to player is less than or equal to 100.5%.

By way of illustration, the weights for lower multipliers in the selected multiplier table for the lowest volatility game option may be higher and the weights for the higher multipliers for the lowest volatility game option in the selected multiplier table may be lower when the number of trigger symbols that initiate the second game is a low number, such as 3. Conversely, the weights for the higher multipliers for the lowest volatility game option in the selected multiplier table may be greater than the weights for the lower multipliers in the selected multiplier table when the number of trigger symbols that initiate the second game is a high number, such as 15. In other words, multiplier tables may be selected so as to increase lowest volatility game option higher multiplier weights as the number of trigger symbols that initiate the second game increase, decrease lowest volatility game option lower multiplier weights as the number of trigger symbols that initiate the second game increase, decrease lowest volatility game option higher multiplier weights as the number of trigger symbols that initiate the second game decrease, and increase lowest volatility game option lower multiplier weights as the number of trigger symbols that initiate the second game decrease. This helps ensure that the lowest volatility game option has the same or similar return to player as the other volatility game options.

Similarly, the lower multipliers for the highest volatility game option in the selected multiplier table may be weighted higher than the higher multipliers when a high number of trigger symbols, such as 15, that initiate the second game land whereas the higher multipliers for the highest volatility game option in the selected multiplier table may be weighted higher than the lower multipliers when a low number of trigger symbols, such as 3, that initiate the second game land. In other words, multiplier tables may be selected to decrease highest volatility game option higher multiplier weights as the number of trigger symbols that initiate the second game increase, increase highest volatility game option lower multiplier weights as the number of trigger symbols that initiate the second game increase, increase highest volatility game option higher multiplier weights as the number of trigger symbols that initiate the second game decrease; and decrease highest volatility game option lower multiplier weights as the number of trigger symbols that initiate the second game decrease.

Multiplier tables may be selected so that weights for the other volatility game options may vary similarly. Various configurations are possible and contemplated without departing from the scope of the present disclosure.

Selecting the one or more multiplier tables may improve the operation of the electronic device compared to generating the one or more multiplier tables on the fly as the electronic device is not required to spend the processing and/or other resources to generate the one or more multiplier tables on the fly. Reducing processing and/or other resources required frees up processing and/or other resources of the electronic device for other tasks and/or requires the electronic device to have less processing and/or other resources in general.

At operation 440, the electronic device may use the selected multiplier table to determine one or more selectable volatility game results. For example, the electronic device may use the one or more multiplier tables to determine when wild symbols land on one or more reels and/or which multiplier values from one or more multiplier value sets to use for the wild symbols, which may multiply the award on any payline that crosses the wild symbol. The electronic device may present the selectable volatility game result via a user interface (such as the bonus game play UI 308 of FIG. 3).

In various examples, this example method 400 may be implemented as a group of interrelated software modules or components that perform various functions discussed herein. These software modules or components may be executed within a cloud network and/or by one or more computing devices, such as the gaming devices 104, 104A-104X, 200 of FIGS. 1, 2A, and/or 2B, the EUD 264a, 264b and 264c of FIG. 2C, and so on.

Although the example method 400 is illustrated and described as including particular operations performed in a particular order, it is understood that this is an example. In various implementations, various orders of the same, similar, and/or different operations may be performed without departing from the scope of the present disclosure.

For example, the above illustrates and describes initiating the second game according to a number of trigger symbols and/or a number of reels on which trigger symbols land. However, it is understood that this is an example and that in other implementations other mechanisms may be used to trigger the second game. By way of example, in some implementations, the second game may be triggered when an entire reel is filled with trigger symbols. Various configurations are possible and contemplated without departing from the scope of the present disclosure.

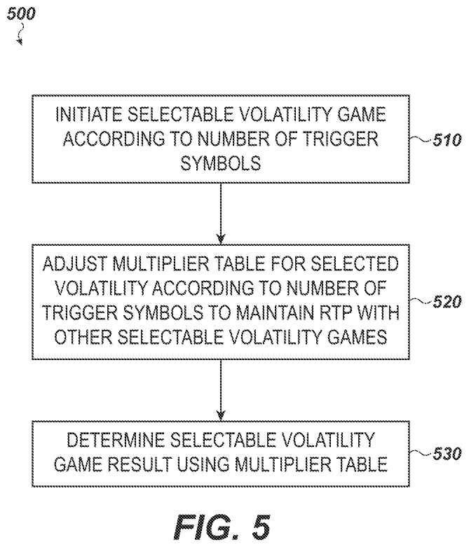

FIG. 5 depicts a flow chart illustrating a second example method 500 for maintaining approximately uniform return to player for multiple volatility options responsive to a number of trigger symbols. The method 500 may be performed by one or more of the devices depicted in FIGS. 1-3.

At operation 510, an electronic device (such as the gaming devices 104, 104A-104X, 200 of FIGS. 1, 2A, and/or 2B, the EUD 264a, 264b and 264c of FIG. 2C, and so on) may initiate a selectable volatility game according to a number of trigger symbols. For example, the electronic device may initiate the selectable volatility game according to a number of reels on which the trigger symbols land (such as 2, 3, and so on), according to a total number of the trigger symbols that land on the reels (such as 5, 6, and so on), whether or not one of the reels is entirely filled with trigger symbols, and so on.

At operation 520, the electronic device may adjust one or more multiplier tables (which may be default multiplier tables) for the selected volatility option according to the number of trigger symbols that initiated the second game. For example, in implementations, the second game may include a number of unlocked and locked game windows. The unlocked game windows may include a number of reels similar to the first game. The locked game windows may be unlocked when a cumulative total of trigger symbols summed from the trigger symbols in the first game that initiated the second game and trigger symbols that landed in the second game reaches a particular number (such as 8, 11, and so on). The second game may use the one or more multiplier tables (such as one per game window) to determine when wild symbols land and/or which multiplier values from one or more multiplier value sets to use for the wild symbols, which may multiply the award on any payline (lines (straight or zig-zagged) that cross one symbol on each reel of a slot type game) that crosses the wild symbol. As is discussed in detail below, the fact that the different volatility options may involve different multipliers and the fact that different numbers of trigger symbols may initiate the second game, resulting in different numbers of game windows being more likely to be unlocked with potentially high multiplier values, using the same multiplier tables regardless of the number of trigger symbols that initiate the second game could result in very different return to player between the highest and lowest volatility options. This may not be allowed by one or more laws, gaming regulations, and so on. However, adjusting one or more multiplier tables for the selected volatility option according to the number of trigger symbols that initiated the second game may enable the chase for the player of having volatility selection while maintaining uniform and/or substantially uniform (and/or similar and/or substantially similar) return to player between the volatility options.

By way of illustration, the weights for lower multipliers in the selected multiplier table for the lowest volatility game option may be adjusted to be higher and the weights for the higher multipliers for the lowest volatility game option in the selected multiplier table may be adjusted to be lower when the number of trigger symbols that initiate the second game is a low number, such as 3. Conversely, the weights for the higher multipliers for the lowest volatility game option in the selected multiplier table may be adjusted to be greater than the weights for the lower multipliers in the selected multiplier table when the number of trigger symbols that initiate the second game is a high number, such as 15. In other words, multiplier tables may be adjusted so as to increase lowest volatility game option higher multiplier weights as the number of trigger symbols that initiate the second game increase, decrease lowest volatility game option lower multiplier weights as the number of trigger symbols that initiate the second game increase, decrease lowest volatility game option higher multiplier weights as the number of trigger symbols that initiate the second game decrease, and increase lowest volatility game option lower multiplier weights as the number of trigger symbols that initiate the second game decrease. This helps ensure that the lowest volatility game option has the same or similar return to player as the other volatility game options.

Similarly, the lower multipliers for the highest volatility game option in the selected multiplier table may be adjusted to be weighted higher than the higher multipliers when a high number of trigger symbols, such as 15, that initiate the second game land whereas the higher multipliers for the highest volatility game option in the selected multiplier table may be adjusted to be weighted higher than the lower multipliers when a low number of trigger symbols, such as 3, that initiate the second game land. In other words, multiplier tables may be adjusted to decrease highest volatility game option higher multiplier weights as the number of trigger symbols that initiate the second game increase, increase highest volatility game option lower multiplier weights as the number of trigger symbols that initiate the second game increase, increase highest volatility game option higher multiplier weights as the number of trigger symbols that initiate the second game decrease; and decrease highest volatility game option lower multiplier weights as the number of trigger symbols that initiate the second game decrease.

Multiplier tables may be adjusted so that weights for the other volatility game options may vary similarly. Various configurations are possible and contemplated without departing from the scope of the present disclosure.

Adjusting one or more multiplier tables may improve the operation of the electronic device compared to storing different multiplier tables for each number of trigger symbols that might initiate the second game as the electronic device is not required to have the storage space free to store them, as well as requiring less time to search among stored data since less data is stored. Reducing required storage means that the electronic device can be configured with fewer storage resources, as well as freeing up processing time not otherwise used to search among a larger amount of stored data.

At operation 530, the electronic device may use the selected multiplier table to determine one or more selectable volatility game results. For example, the electronic device may use the one or more multiplier tables to determine the values of one or more wild symbols that the electronic device determines land on one or more reels and/or whether or not such wild symbols land on the one or more reels, which may multiply the award on any payline that crosses the wild symbol.

In various examples, this example method 500 may be implemented as a group of interrelated software modules or components that perform various functions discussed herein. These software modules or components may be executed within a cloud network and/or by one or more computing devices, such as the gaming devices 104, 104A-104X, 200 of FIGS. 1, 2A, and/or 2B, the EUD 264a, 264b and 264c of FIG. 2C, and so on.

Although the example method 500 is illustrated and described as including particular operations performed in a particular order, it is understood that this is an example. In various implementations, various orders of the same, similar, and/or different operations may be performed without departing from the scope of the present disclosure.

For example, the above illustrates and describes initiating the selectable volatility game according to a number of trigger symbols. However, it is understood that this is an example. In some implementations, triggering of the second game may be independent of the number of trigger symbols but the trigger symbols may affect the volatility, game play, and/or other aspect of the second game. Various configurations are possible and contemplated without departing from the scope of the present disclosure.

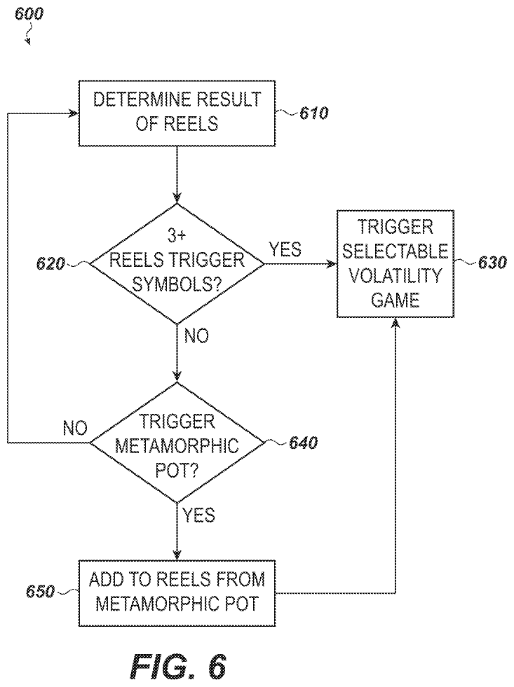

FIG. 6 depicts a flow chart illustrating an example method 600 for initiating a selectable volatility game. The method 600 may be performed by one or more of the devices depicted in FIGS. 1-3.

At operation 610, an electronic device (such as the gaming devices 104, 104A-104X, 200 of FIGS. 1, 2A, and/or 2B, the EUD 264a, 264b and 264c of FIG. 2C, and so on) may determine the result of a number of reels. For example, the reels may be part of a first game that may be a slot type game that is operable to trigger a second game, which may be a selectable volatility game, a bonus game, and so on.

At operation 620, the electronic device may determine whether or not trigger symbols land on at least 3 of the reels. If so, the flow may proceed to operation 630 where the electronic device triggers the selectable volatility game. Otherwise, the flow may proceed to operation 640.

At operation 640, after the electronic device determines that trigger symbols do not land on at least three of the reels, the electronic device may determine whether or not to trigger a metamorphic pot. If not, the flow may return to operation 610 where the electronic device may again determine the result of the reels. Otherwise, the flow may proceed to operation 650.

At operation 650, the electronic device may add one or more trigger symbols from the metamorphic pot to one or more of the reels. The flow may then proceed to operation 630 and trigger the selectable volatility game.

In some examples, the electronic device may contribute one or trigger symbols from the reels during play of the first game to the metamorphic pot. In such examples, the electronic device may control one or more displays to indicate the metaphoric pot (such as visually indicated) in one of multiple (such as three, five, ten, and so on) metamorphic stages. The multiple metamorphic stages may each be progressively more intense. By way of illustration, a first metamorphic stage may illustrate the metamorphic pot as empty whereas later metamorphic stages may show the metamorphic pot as fuller and the final metamorphic stage illustrates the metamorphic pot as near overflowing. Alternatively and/or additionally, the metamorphic pot may be illustrated as glowing in subsequent metamorphic stages and the glow may increase in intensity as metamorphic stages progress. Each time that a trigger symbol is contributed to the metamorphic pot, the electronic device may determine whether or not to control a display to indicate that the metamorphic pot increments to a next metamorphic stage of the multiple metamorphic stages. The electronic device may use a weighted table to determine whether or not to increment the metamorphic pot to the next metamorphic stage.

Additionally, the electronic device may determine whether or not to add the trigger symbols to the reels from the metaphoric post using the weighted table, using another weighted table, and/or another mechanism. The electronic device may use the weighted table to determine whether or not to modify the reels according to a number of trigger symbols present on the reels and/or a number of the reels on which the trigger symbols are present. The electronic device may also use the weighted table to determine the number of trigger symbols to add to the reels, which may also be according to a number of trigger symbols present on the reels and/or a number of the reels on which the trigger symbols are present. The electronic device may then determine whether or not to trigger the selectable volatility game at operation 630 according to the modified reels (such as according to whether there are trigger symbols now present on at least three of the modified reels).

In some examples, the electronic device may be configured to first add the one or more trigger symbols from the metamorphic pot to ones of the reels where trigger symbols are not already present. In this way, the first game may ensure that triggering of the second game may be more likely. In some examples, the first game may be configured to only add up to a number of trigger symbols from the metamorphic pot that corresponds to the number of symbol positions defined by the reels less the number of trigger symbols that are already present on the reels.

In various examples, this example method 600 may be implemented as a group of interrelated software modules or components that perform various functions discussed herein. These software modules or components may be executed within a cloud network and/or by one or more computing devices, such as the gaming devices 104, 104A-104X, 200 of FIGS. 1, 2A, and/or 2B, the EUD 264a, 264b, and 264c of FIG. 2C, and so on.

Although the example method 600 is illustrated and described as including particular operations performed in a particular order, it is understood that this is an example. In various implementations, various orders of the same, similar, and/or different operations may be performed without departing from the scope of the present disclosure.

For example, the above illustrates and describes triggering the selectable volatility game when trigger symbols land on 3 or more of the reels. However, it is understood that this is an example. In other implementations, the selectable volatility game may be triggered according to a total number of the trigger symbols that land on the reels (such as 5, 6, and so on), whether or not one of the reels is entirely filled with trigger symbols, and so on. Various configurations are possible and contemplated without departing from the scope of the present disclosure.

By way of another example, the above illustrates and describes triggering the selectable volatility game after adding to the reels from the metamorphic pot. However, it is understood that this is an example. In some implementations, the electronic device may instead determine whether or not adding to the reels from the metamorphic pot triggers the selectable volatility game. If so, the flow may proceed to operation 630. Otherwise, the flow may return to operation 610 where the electronic device may again determine the result of the reels. Various configurations are possible and contemplated without departing from the scope of the present disclosure.

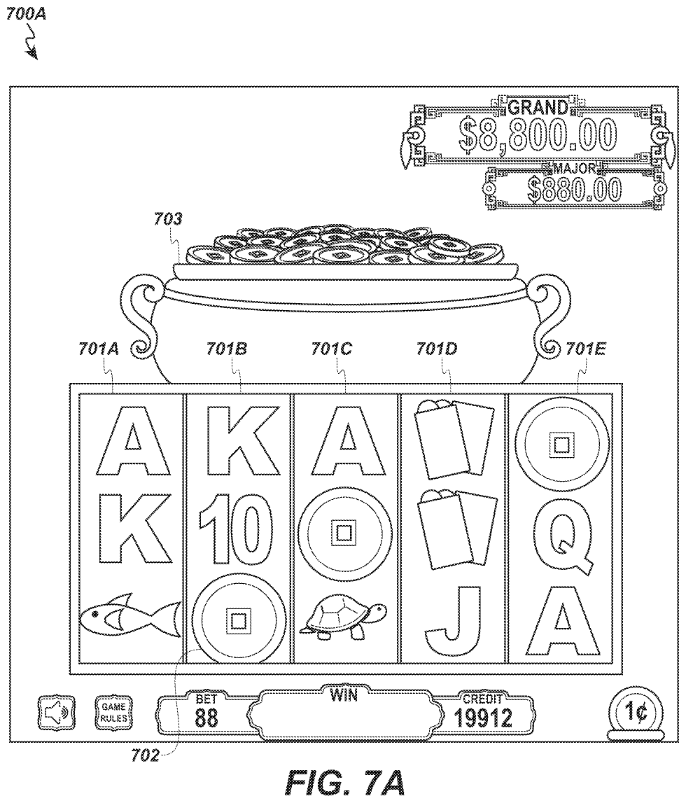

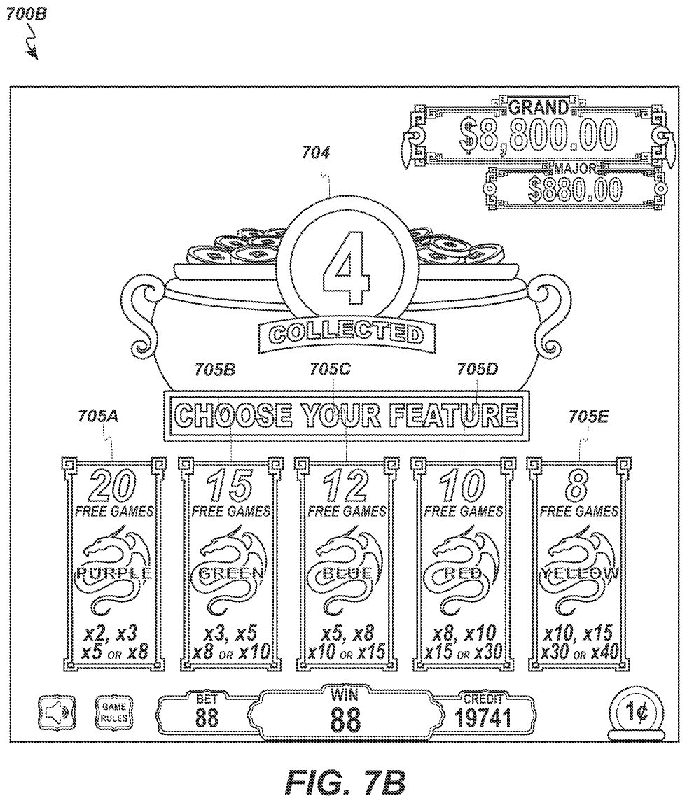

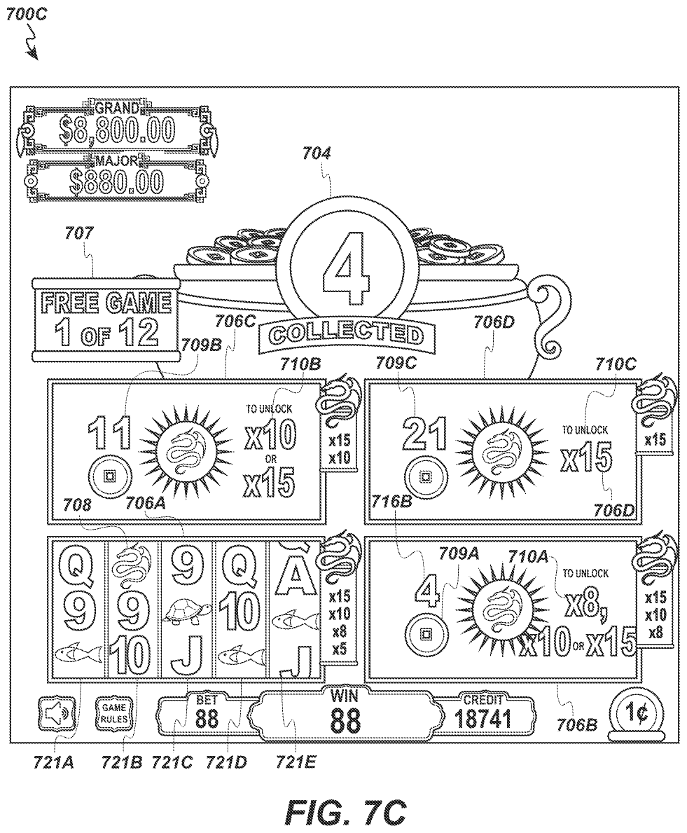

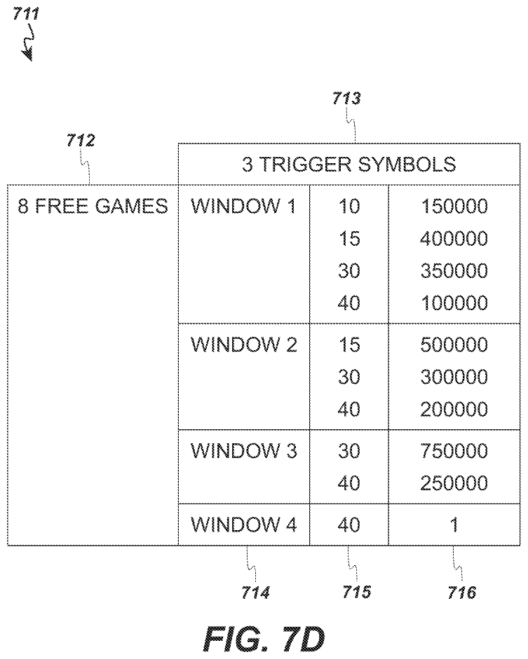

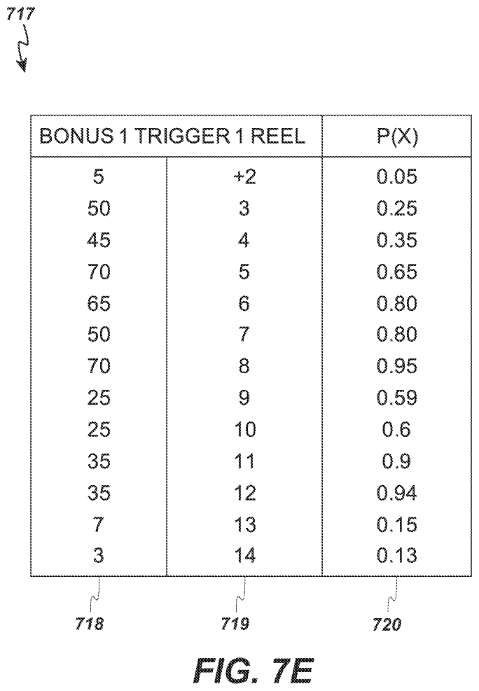

FIG. 7A depicts a first screen 700A of a first game. The first game may be a slot type game including a number of reels 701A-701E that define a number of symbol positions upon which a number of symbols may land. In this example, the 5 reels 701A-701E each define 5 symbol positions for a total of 15 symbol positions. The symbol positions of the reels 701A-701E may be filled from one or more reel strips, which may include one or more symbols, such as trigger symbols 702. Upon initiating play, a random number generator may be used to determine a stop position for the reels 701A-701E. Symbols on the reels 701A-701E along one or more paylines may be compared to one or more pay-tables to determine the outcome of the game and/or any award.

Additionally, one or more of the symbols may be a trigger symbol 702. A trigger symbol 702 may be a symbol that triggers one or more actions. The trigger symbol 702 may be a scatter symbol (symbols that provide something in response to having the right number of them present anywhere on the reels 701A-701E). As illustrated in this example, the trigger symbol 702 in the first game may be a coin. In the first game, the presence of trigger symbols 702 on at least three of the reels 701A-701E may trigger a second game, which may be a selectable volatility game, a bonus game and/or feature, and so on. This is an unconventional technical solution to how to use existing mechanisms to trigger events without adding additional complexity and storage requirements to games and/or machines that implement such games beyond the conventional triggering mechanism of triggering from left to right. The selectable volatility game is discussed in more detail below. As the first game may trigger the second game, the first game may be a trigger game.

In addition to the presence of trigger symbols 702 on at least three (and/or another threshold number) of the reels 701A-701E triggering the second game, the first game may include a metamorphic feature (a feature where free games, feature games, prizes (other than jackpots), and so on may be triggered by the cumulative result of a series of plays) operable to trigger the second game.

For example, presence of trigger symbols 702 in any of the reels 701A-701E may trigger a contribution to the metaphoric pot 703. Contribution to the metaphoric pot 703 may involve controlling a display to animate a contribution streak from one or more of the reels 701A-701E to the metamorphic pot 703.

The metaphoric pot 703 may be indicated (such as visually indicated) in one of multiple (such as three, five, ten, and so on) metamorphic stages. The multiple metamorphic stages may each be progressively more intense. By way of illustration, a first metamorphic stage may illustrate the metamorphic pot 703 as empty whereas later metamorphic stages may show the metamorphic pot 703 as fuller and the final metamorphic stage illustrates the metamorphic pot 703 as near overflowing. Alternatively and/or additionally, the metamorphic pot 703 may be illustrated as glowing in subsequent metamorphic stages and the glow may increase in intensity as metamorphic stages progress. Each time that a trigger symbol 702 is contributed to the metamorphic pot 703, the first game may determine whether or not to control a display to indicate that the metamorphic pot 703 increments to a next metamorphic stage of the multiple metamorphic stages. The first game may use a weighted table to determine whether or not to increment the metamorphic pot 703 to the next metamorphic stage.

Additionally, each time that a trigger symbol 702 is contributed to the metamorphic pot 703, the first game may determine whether or not to modify the reels 701A-701E by adding one or more trigger symbols 702 from the metamorphic pot 703 to the reels 701A-701E. The first game may determine whether or not to modify the reels 701A-701E using the weighted table, using another weighted table, and/or another mechanism. The first game may use the weighted table to determine whether or not to modify the reels 701A-701E according to a number of trigger symbols present on the reels and/or a number of the reels 701A-701E on which the trigger symbols are present. The first game may also use the weighted table to determine the number of trigger symbols 702 to add to the reels 701A-701E, which may also be according to a number of trigger symbols present on the reels and/or a number of the reels 701A-701E on which the trigger symbols are present. The first game may then determine whether or not to trigger the second game according to the modified reels 701A-701E (such as according to whether there are trigger symbols 702 now present on at least three of the modified reels 701A-701E).

In some examples, the first game may be configured to first add the one or more trigger symbols 702 from the metamorphic pot 703 to ones of the reels 701A-701E where trigger symbols 702 are not already present. In this way, the first game may ensure that triggering of the second game may be more likely. In some examples, the first game may be configured to only add up to a number of trigger symbols 702 from the metamorphic pot 703 that corresponds to the number of symbol positions defined by the reels 701A-701E (or 15) less the number of trigger symbols 702 that are already present on the reels 701A-701E.

FIG. 7B depicts a volatility selection screen 700B illustrating multiple volatility options 705A-705E for a second game that may be initiated from the first game. The volatility selection screen 700B may illustrate an indicator 704 indicating a number of trigger symbols that triggered the second game as well as a number of volatility options 705A-705E. In this example, the lowest volatility game option 705A may provide 20 free games and may include a first set of multiplier values 2, 3, 5, and 8. Further, in this example, the second lowest volatility game option 705B may provide 15 free games and may include a second set of multiplier values 3, 5, 8, and 10. Additionally, in this example, the middle volatility game option 705C may provide 12 free games and may include a third set of multiplier values 5, 8, 10, and 15. Moreover, in this example, the second highest volatility option 705D may provide 10 free games and may include a fourth set of multiplier values 8, 10, 15, and 30. Further, in this example, the highest volatility game option 705E may provide 8 free games and may include a fifth set of multiplier values 10, 15, 30, and 40. When the free games provided by the respective volatility selection run out, the second game may pay out all ways and end. Additional free games may be awarded during play of the second game, such as for when trigger symbols land, when game windows are unlocked, and/or the occurrence of other events.

FIG. 7C depicts a screen 700C of the second game after a volatility selection corresponding to the middle volatility option 705C in FIG. 7B is received. The screen 700C may include a number of locked and/or unlocked game windows 706A-706D. As shown, the game window 706A may be unlocked and game windows 706B-706D may be locked.

In this example, the game window 706A may always be unlocked and each of the game windows 706B-706D may be unlocked when a cumulative (which may be the sum of trigger symbols from the first game that triggered the second game and all trigger symbols that have landed during the second game, which may span the number of free games indicated by the free game indicator 707) trigger symbol total reaches a respective unlock window threshold, indicated by the indicators 709A, 709B, and 709C. Given that the maximum number of trigger symbols from the first game in this example is 15, the second game may be initiated with either or both of the game windows 706A-706B unlocked and both of the game windows 706C-706D locked.

When unlocked, the game windows 706A-706D may each display a number of reels, such as the reels 721A-721E for game window 706A. For the most part, the reels for the unlocked game windows 706A-706D may operate similarly to the reels 701A-701E in FIG. 7A. However, when triggering symbols land on the reels for the unlocked game windows 706A-706D (though in some examples triggering symbols may not land on reels in the game window 706D after the game window 706D is unlocked), the indicator 704 may be incremented accordingly and any locked game windows 706B-706D may be unlocked if a respective unlock window threshold for the locked game windows 706B-706D has been reached. Further, the second game may use one or more multiplier tables to determine whether or not to add one or more wild symbols 708 that correspond to one or more of multiplier values in one or more sets of multiplier values from the multiplier tables. The second game may multiply the multiplier values by any award that is along a payline that intersects the multiplier values on the reels for the unlocked game windows 706A-706D.

As mentioned above, FIG. 7C depicts a screen 700C of the second game after a volatility selection corresponding to the middle volatility option 705C in FIG. 7B is received. As such, the game window 706A may use the full corresponding set of multiplier values 5, 8, 10, and 15. However, the other game windows 706B-706D may only use a portion of the set of multiplier values 5, 8, 10, and 15. For example, when unlocked, the game window 706B may use the 8, 10, and 15 portion of the set of multiplier values, indicated by the indicator 710A. By way of another example, when unlocked, the game window 706C may use the 10 and 15 portion of the set of multiplier values, indicated by the indicator 710B. By way a third example, when unlocked, the game window 706D may use only the 15 portion of the set of multiplier values, indicated by the indicator 710C.

With reference again to FIGS. 7A-7C, given the volatility in the number of free games provided by each of the volatility options 705A-705E in FIG. 7B and the variance between the sets of multipliers used in each, the return to player between the highest and the lowest of the volatility options 705A-705E may vary greatly depending on the number of trigger symbols 702 that initiated the second game if the same multiplier tables were used regardless of the number of trigger symbols 702 that initiated the second game. This is because the more trigger symbols 702 that initiate the second game, the more likely additional game windows 706B-706D will open during play of the second game, increasing the likelihood that higher of the multiplier values will land. However, rather than the conventional solution of using the same multiplier tables and accepting variance in return to player, the second game provides the unconventional technical solution of selecting and/or adjusting multiplier tables according to the number of trigger symbols 702 that initiate the second game and/or the volatility selection. This may maintain each of the volatility options 705A-705E at a uniform and/or substantially uniform (and/or similar and/or substantially similar) return to player, which may be required by law and/or applicable regulation. As such, the game play of the second game is improved by enabling players to have the chase of selecting between the volatility options 705A-705E while satisfying applicable laws and/or regulations regarding uniform and/or substantially uniform return to player.

By way of illustration, the weights for the 2 and 3 multipliers for the lowest volatility game option 705A may be higher and the weights for the 5 and 8 multipliers for the lowest volatility game option 705A may be lower when the number of trigger symbols 702 that initiate the second game is 3. Conversely, the weights for the 5 and 8 multipliers for the lowest volatility game option 705A may be greater than the weights for the 2 and 3 multipliers when the number of trigger symbols 702 that initiate the second game is 15. In other words, the second game may increase lowest volatility game option higher multiplier weights as the number of trigger symbols 702 that initiate the second game increase, decrease lowest volatility game option lower multiplier weights as the number of trigger symbols 702 that initiate the second game increase, decrease lowest volatility game option higher multiplier weights as the number of trigger symbols 702 that initiate the second game decrease, and increase lowest volatility game option lower multiplier weights as the number of trigger symbols 702 that initiate the second game decrease. The reason for this is that the number of trigger symbols 702 that initiate the second game affect the number of game windows 706A-706D that are unlocked and other volatility options have larger multiplier values. This helps ensure that the lowest volatility game option 705A has the same or similar return to player as the other volatility game options 705B-705E.

Similarly, the 10 and 15 multipliers for the highest volatility game option 705E may be weighted higher than the 30 and 40 multipliers when 15 trigger symbols 702 that initiate the second game land whereas the 30 and 40 multipliers for the highest volatility game option 705E may be weighted higher than the 10 and 15 multipliers when 3 trigger symbols 702 that initiate the second game land. In other words, the second game may decrease highest volatility game option higher multiplier weights as the number of trigger symbols 702 that initiate the second game increase, increase highest volatility game option lower multiplier weights as the number of trigger symbols 702 that initiate the second game increase, increase highest volatility game option higher multiplier weights as the number of trigger symbols 702 that initiate the second game decrease; and decrease highest volatility game option lower multiplier weights as the number of trigger symbols 702 that initiate the second game decrease.

The weights for the other volatility game options 705B-705D may vary similarly. Various configurations are possible and contemplated without departing from the scope of the present disclosure.

As described above, in some examples, multiplier tables corresponding to one or more different numbers of trigger symbols 702 may be stored and selected upon initiation of the second game. Storage of the different multiplier tables may improve operational efficiency of one or more processors and/or other devices that implement the second game by reducing the amount of processing that would otherwise be done by creating the different multiplier tables on the fly. However, it is understood that this is an example. In other examples, a default multiplier table may be used that may then be adjusted upon initiation of the second game according to the number of trigger symbols 702 that initiate the second game and/or the volatility selection. Adjustment of the default multiplier tables on the fly may reduce storage medium used to implement the second game by reducing the amount of multiplier tables that would otherwise need to be stored. Various configurations are possible and contemplated without departing from the scope of the present disclosure.

Further, the above describes selecting a different multiplier table and/or adjusting a default multiplier table for each different number of trigger symbols 702 that initiate the second game. However, it is understood that this is an example. In other examples, different multiplier tables may be selected and/or a default table may be adjusted when the different number of trigger symbols 702 crosses different thresholds, such as a first threshold of 3-5 trigger symbols 702 that initiate the second game, a second threshold of 6-8 trigger symbols 702 that initiate the second game, a third threshold of 9-11 trigger symbols 702 that initiate the second game, a fourth threshold of 11-13 trigger symbols 702 that initiate the second game, a fifth threshold of 14-15 trigger symbols 702 that initiate the second game, and so on. This may minimize the number of different multiplier tables to be stored and/or to be adjusted. Various configurations are possible and contemplated without departing from the scope of the present disclosure.

As also described above, in various examples, different multiplier tables may be used for each of the game windows 706A-706D.

FIG. 7D depicts an example multiplier table 711 that may be used with the second game. As shown, the example multiplier table 711 specifies an associated number of free games 712 that is associated with a selected volatility game option corresponding to the example multiplier table 711, a number of trigger symbols 713 associated with the example multiplier table 711, different multipliers 715 for different game windows 714 and the weights associated with the different multipliers 715 for the different game windows 714. However, it is understood that this is an example. Various other table formats and/or data may be used without departing from the scope of the present disclosure.

FIG. 7E depicts an example weighted table 717 that may be used with the first game. As illustrated, the example weighted table 717, which corresponds to 1 trigger symbol being present on one reel, includes weights 718 for different numbers of trigger symbols to add 719 and different probabilities for each 720. However, it is understood that this is an example. Various other table formats and/or data may be used without departing from the scope of the present disclosure.

Although the second game is illustrated and described with respect to FIGS. 7A-7E with a particular configuration of particular features, it is understood that this is an example. In other examples, other configurations of the same, similar, and/or different features may be used. Various configurations are possible and contemplated without departing from the scope of the present disclosure.

By way of example, the above illustrates and describes particular numbers of volatility selections, game windows, reels, and so on. However, it is understood that this is an example and that in other implementations other numbers of volatility selections, game windows, reels, and so on may be used without departing from the scope of the present disclosure.

By way of another example, the above illustrates and describes particular multipliers, multiplier tables, weight tables, and so on. However, it is understood that this is an example and that in other implementations other multipliers, multiplier tables, weight tables, and so on may be used. Various configurations are possible and contemplated without departing from the scope of the present disclosure.

By way of a third example, the above illustrates and describes triggering the second game in response to trigger symbols landing on at least three reels. However, it is understood that this is an example. In other implementations, the second game may be triggered when a particular number of trigger symbols (such as 5, 6, and so on) land on any number of reels. In yet other examples, the second game may be triggered when an entire reel is filled with trigger symbols. Various configurations are possible and contemplated without departing from the scope of the present disclosure.

In yet another example, the above illustrates and describes selecting and/or adjusting multiplier tables according to the number of trigger symbols that trigger the second game in order to maintain return to player among multiple volatility options. However, it is understood that this is an example. In other examples, the trigger symbols that land may be adjusted dynamically so that the likelihood of trigger symbols landing in the second game decreases as the number of trigger symbols that initiate the second game increase. In some such examples, the likelihood of trigger symbols landing in the second game may decrease differently for different volatility selections as the number of trigger symbols that initiate the second game increase. Various configurations are possible and contemplated without departing from the scope of the present disclosure.

In still other examples, the above illustrates and describes selecting and/or adjusting multiplier tables upon initiation of the second game. However, it is understood that this is an example. In other implementations, multiplier tables may be selected and/or adjusted at one or more other times. Various configurations are possible and contemplated without departing from the scope of the present disclosure.

In various implementations, a system may include a non-transitory storage medium that stores instructions and a processor. The processor may execute the instructions to initiate a first game in response to a number of trigger symbols on first reels of a second game, receive a volatility selection from multiple volatility options for the first game, select at least one multiplier table that is stored in the non-transitory storage medium according to the volatility selection and the number of trigger symbols on the first reels of the second game to maintain return to player among the multiple volatility options, and use the at least one multiplier table to determine whether at least one multiplier value lands on second reels of the first game.

In some examples, a first of the multiple volatility options may include a first number of plays and a first set of multiplier values, a second of the multiple volatility options may include a second number of plays and a second set of multiplier values, the first number of plays may be greater than the second number of plays, and the second set of multiplier values may be greater than the first set of multiplier values.

In a number of examples, the first game may include a number of game windows. In various such examples, the number of game windows may include at least one unlocked game window and at least one locked game window. In some such examples, the processor may be operable to unlock the at least one locked game window according to a sum of a cumulative trigger symbol total for the first game and the number of trigger symbols on the first reels of the second game. In a number of such examples, the processor may be operable to determine a game outcome for each of the game windows that are unlocked. In various such examples, the at least one multiplier table may include multiple multiplier tables wherein each of the multiple multiplier tables corresponds to one of the number of game windows.

In some implementations, a system may include a non-transitory storage medium that stores instructions and a processor. The processor may execute the instructions to receive a volatility selection from multiple volatility options for a selectable volatility game initiated from an outcome of a trigger game, adjust at least one multiplier table that is stored in the non-transitory storage medium according to the volatility selection and a number of trigger symbols on first reels of the trigger game to maintain return to player among the multiple volatility options, and use the at least one multiplier table to determine whether at least one multiplier value lands on second reels of the selectable volatility game.

In various examples, the at least one multiplier value landing on the second reels of the selectable volatility game may correspond to a wild symbol on the second reels of the selectable volatility game. In some examples, the processor may adjust the at least one multiplier table by increasing lowest volatility game option higher multiplier weights as the number of trigger symbols on the first reels of the trigger game increase, decreasing lowest volatility game option lower multiplier weights as the number of trigger symbols on the first reels of the trigger game increase, decreasing lowest volatility game option higher multiplier weights as the number of trigger symbols on the first reels of the trigger game decrease, and increasing lowest volatility game option lower multiplier weights as the number of trigger symbols on the first reels of the trigger game decrease.

In a number of examples, the processor may adjust the at least one multiplier table by decreasing highest volatility game option higher multiplier weights as the number of trigger symbols on the first reels of the trigger game increase, increasing highest volatility game option lower multiplier weights as the number of trigger symbols on the first reels of the trigger game increase, increasing highest volatility game option higher multiplier weights as the number of trigger symbols on the first reels of the trigger game decrease, and decreasing highest volatility game option lower multiplier weights as the number of trigger symbols on the first reels of the trigger game decrease. In various examples, the processor may award an additional play of the selectable volatility game upon determining to unlock a locked game window. In some examples, the at least one multiplier table may include a first multiplier table with a first number of multipliers and a second multiplier table with a second number of multipliers that is less than the first number of multipliers.

In a number of implementations, a system may include a non-transitory storage medium that stores instructions and a processor. The processor may execute the instructions to, upon determining that trigger symbols are present on a threshold number of reels in a first game, initiating a second game and upon determining that the trigger symbols are present on a number of the reels in the first game that is less than the threshold number: contribute to a metamorphic pot, use a weighted table that is stored in the non-transitory storage medium to determine whether to modify the reels in the first game by adding one or more trigger symbols from the metamorphic pot to the reels in the first game according to a number of trigger symbols present on the reels in the first game and the number of the reels in the first game on which the trigger symbols are present, and determine whether to initiate the second game after modifying the reels in the first game.

In some examples, upon contributing to the metamorphic pot, the processor may initiate control of a display to animate a contribution streak from the reels in the first game to the metamorphic pot. In a number of examples, the processor may be operable to initiate control of a display to indicate that the metamorphic pot is in one of multiple metamorphic stages and, upon contributing to the metamorphic pot, the processor may be operable to initiate the control of the display to indicate that the metamorphic pot increments to a next metamorphic stage of the multiple metamorphic stages. In various examples, the processor may use the weighted table to determine whether to increment the metamorphic pot to the next metamorphic stage. In some examples, the second game may be a selectable volatility game. In a number of examples, the processor may add the one or more trigger symbols from the metamorphic pot to a first reel of the reels in the first game where the one or more trigger symbols are not present before a second reel of the reels in the first game where the one or more trigger symbols are present. In various examples, the weighted table may include an entry for adding a maximum number of trigger symbols that is one less than a number of symbol positions defined by the reels in the first game.

Although the above illustrates and describes a number of embodiments, it is understood that these are examples. In various implementations, various techniques of individual embodiments may be combined without departing from the scope of the present disclosure.

As discussed above, a selectable volatility game may be initiated in a triggering game related to a number of trigger symbols landing on a number of reels. The selectable volatility game may utilize one or more multiplier tables. However, there may be significant variance in the return to player between the highest and lowest volatility options for the volatility selectable game depending on whether the number of trigger symbols is low or high. This kind of variance in return to player between volatility options in a selectable volatility game may not be permitted by law, regulation, and so on. In order to maintain uniform and/or substantially uniform return to player between volatility options in a selectable volatility game, the present disclosure may select and/or adjust one or more multiplier tables according to the number of trigger symbols. In this way, a player may be provided the chase corresponding to a selectable volatility game while ensuring that the return to player between volatility options in a selectable volatility game remains uniform and/or substantially uniform.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system, comprising:
a non-transitory storage medium that stores instructions; and
a processor that executes the instructions to:
initiate a first game in response to a number of trigger symbols on first reels of a second game;
receive a volatility selection from multiple volatility options for the first game;
select at least one multiplier table that is stored in the non-transitory storage medium according to the volatility selection and the number of trigger symbols on the first reels of the second game to maintain return to player among the multiple volatility options; and
use the at least one multiplier table to determine whether at least one multiplier value lands on second reels of the first game.

2. The system of claim 1, wherein:
a first of the multiple volatility options comprises a first number of plays and a first set of multiplier values;
a second of the multiple volatility options comprises a second number of plays and a second set of multiplier values;
the first number of plays is greater than the second number of plays; and
the second set of multiplier values is greater than the first set of multiplier values.

3. The system of claim 1, wherein the first game includes a number of game windows.

4. The system of claim 3, wherein the number of game windows includes at least one unlocked game window and at least one locked game window.

5. The system of claim 4, wherein the processor is operable to unlock the at least one locked game window according to a sum of a cumulative trigger symbol total for the first game and the number of trigger symbols on the first reels of the second game.

6. The system of claim 4, wherein the processor is operable to determine a game outcome for each of the game windows that are unlocked.

7. The system of claim 3, wherein the at least one multiplier table comprises multiple multiplier tables wherein each of the multiple multiplier tables corresponds to one of the number of game windows.

8. A system, comprising:
a non-transitory storage medium that stores instructions; and
a processor that executes the instructions to:
receive a volatility selection from multiple volatility options for a selectable volatility game initiated from an outcome of a trigger game;
adjust at least one multiplier table that is stored in the non-transitory storage medium according to the volatility selection and a number of trigger symbols on first reels of the trigger game to maintain return to player among the multiple volatility options; and
use the at least one multiplier table to determine whether at least one multiplier value lands on second reels of the selectable volatility game.

9. The system of claim 8, wherein the at least one multiplier value landing on the second reels of the selectable volatility game corresponds to a wild symbol on the second reels of the selectable volatility game.

10. The system of claim 8, wherein the processor adjusts the at least one multiplier table by:
increasing lowest volatility game option higher multiplier weights as the number of trigger symbols on the first reels of the trigger game increase;
decreasing lowest volatility game option lower multiplier weights as the number of trigger symbols on the first reels of the trigger game increase;
decreasing lowest volatility game option higher multiplier weights as the number of trigger symbols on the first reels of the trigger game decrease; and
increasing lowest volatility game option lower multiplier weights as the number of trigger symbols on the first reels of the trigger game decrease.

11. The system of claim 8, wherein the processor adjusts the at least one multiplier table by:
decreasing highest volatility game option higher multiplier weights as the number of trigger symbols on the first reels of the trigger game increase;
increasing highest volatility game option lower multiplier weights as the number of trigger symbols on the first reels of the trigger game increase;
increasing highest volatility game option higher multiplier weights as the number of trigger symbols on the first reels of the trigger game decrease; and
decreasing highest volatility game option lower multiplier weights as the number of trigger symbols on the first reels of the trigger game decrease.

12. The system of claim 8, wherein the processor awards an additional play of the selectable volatility game upon determining to unlock a locked game window.

13. The system of claim 8, wherein the at least one multiplier table comprises:
a first multiplier table with a first number of multipliers; and
a second multiplier table with a second number of multipliers that is less than the first number of multipliers.

14. A system, comprising:
a non-transitory storage medium that stores instructions; and
a processor that executes the instructions to:
upon determining that trigger symbols are present on a threshold number of reels in a first game, initiate a second game; and
upon determining that the trigger symbols are present on a number of the reels in the first game that is less than the threshold number:
contribute to a metamorphic pot;
use a weighted table that is stored in the non-transitory storage medium to determine whether to modify the reels in the first game by adding one or more trigger symbols from the metamorphic pot to the reels in the first game according to a number of trigger symbols present on the reels in the first game and the number of the reels in the first game on which the trigger symbols are present; and
determine whether to initiate the second game after modifying the reels in the first game.

15. The system of claim 14, wherein, upon contributing to the metamorphic pot, the processor initiates control of a display to animate a contribution streak from the reels in the first game to the metamorphic pot.

16. The system of claim 14, wherein:
the processor is operable to initiate control of a display to indicate that the metamorphic pot is in one of multiple metamorphic stages; and
upon contributing to the metamorphic pot, the processor is operable to initiate the control of the display to indicate that the metamorphic pot increments to a next metamorphic stage of the multiple metamorphic stages.

17. The system of claim 16, wherein the processor uses the weighted table to determine whether to increment the metamorphic pot to the next metamorphic stage.

18. The system of claim 14, wherein the second game is a selectable volatility game.

19. The system of claim 14, wherein the processor adds the one or more trigger symbols from the metamorphic pot to a first reel of the reels in the first game where the one or more trigger symbols are not present before a second reel of the reels in the first game where the one or more trigger symbols are present.

20. The system of claim 14, wherein the weighted table includes an entry for adding a maximum number of trigger symbols that is one less than a number of symbol positions defined by the reels in the first game.
